(19) United States
(12) Patent Application Publication
(10) Pub. No.: US 2007/0159015 A1
(43) Pub. Date: Jul. 12, 2007

(54) Centrifugal fan and its stator structure

(75) Inventors: Yu-Chih Lin, Taoyuan Hsien (TW); Hung-Chi Chen, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/651,450

(22) Filed: Jan. 10, 2007

(30) Foreign Application Priority Data
Jan. 11, 2006 (TW) 095100999

(51) Int. Cl. H02K 11/00; H02K 5/10; H02K 5/00; F04B 35/04

(52) U.S. Cl. 310/71; 417/423.14; 417/423.7; 310/88; 310/89

(57) ABSTRACT

A base structure of a centrifugal fan comprises a base and a fixing element. The base has a recess disposed at the edge of the base. The fixing element has a first end and a second end. The first end is connected with the base. The second end covers the recess.

### CROSS REFERENCE TO RELATED APPLICATIONS

This Non-provisional application claims priority under 35 U.S.C. §119(a) on Patent Application No(s). 095100999 filed in Taiwan, Republic of China on Jan. 11, 2006, the entire contents of which are hereby incorporated by reference.

### BACKGROUND OF THE INVENTION

1. Field of Invention

The invention relates to a fan and its stator structure and base structure. In particular, the invention relates to a centrifugal fan and its stator structure and base structure.

2. Related Art

Due to the advance in modem technologies, most multimedia devices and large/small electronic devices use many electronic elements for better performance and more functions. Therefore, they have a higher demand for heat dissipation. This is because the ability for heat dissipation directly affects the lifetime of the electronic devices.

Fans are common heat-dissipating devices. As shown in FIG. 1, a conventional centrifugal fan 1 includes an impeller 11, a base 12, and a motor (not shown) disposed at the bottom of the base 12. The impeller 11 has several blades 111 and is connected to the motor. The motor is electrically connected to a system via a wire 13 and an opening 121 at the edge of the base 12.

As shown in FIG. 1, the prior art uses a wire band L to fix the wire 13. However, the wire band L and the wire 13 are not fixed to the base 12. They can easily move in the opening 121 at any direction. When the wire 13 is pulled by an external force, it can be easily pulled away from the motor because it is not fixed. The centrifugal fan 1 therefore cannot operate. Besides, since the wire 13 cannot cover the opening 121, dust or moisture may enter the base 12 via the opening 121.

Consequently, it is desirable to provide a fixable wire that can prevent dust and moisture from entering the centrifugal fan and its stator and base structures.

### SUMMARY OF THE INVENTION

In view of the foregoing, the invention is to provide a fixable wire that can effective prevent dust and moisture from entering the centrifugal fan and its stator and base structures.

To achieve the above, a base structure according to the invention comprises a body and a fixing element. The body has a recess, and a stator magnetic pole is disposed inside the body. The fixing element has a first end and a second end. The first end is connected with the body, and the second end correspondingly covers the recess.

To achieve the above, the invention discloses a stator structure comprising at least one base structure and at least one stator magnetic pole. A rotor structure is disposed corresponding to the stator structure. The base structure comprises a body and at least one fixing element. The body has at least one recess. The stator magnetic pole is disposed inside the body. The fixing element has a first end and a second end. The first end is connected with the body, and the second end covers the recess.

To achieve the above, the invention also discloses a fan, which comprises a rotor structure and a stator structure disposed correspondingly. The stator structure has at least one base structure and at least one stator magnetic pole. The base structure comprises a body having at least one recess and at least one fixing element. The stator magnetic pole is disposed inside the body. The fixing element has a first end connected to the body and a second end covering the recess.

As mentioned above, the centrifugal fan and its stator and base structures of the invention enable a wire to readily and rapidly go through a recess of the body by a suitable combination of the body and the fixing element. The fixing element fixes the wire for the convenience of the assembly. Besides, the wire can be first fixed to an opening of the fixing element before assembling the wire and the fixing element to the body. Through this method, the wire can also be installed easily and rapidly. In comparison with the prior art, the invention uses a fixing element to fix the wire in the recess, enhancing the strength against external forces of the wire. Moreover, after the fixing element fixes the wire, it also covers the recess to prevent dust and moisture from entering the centrifugal fan via the recess.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional centrifugal fan;

FIG. 2 is a schematic view of a base structure of a centrifugal fan according to a preferred embodiment of the invention;

FIGS. 3 to 5B are schematic views showing different connection methods for the fixing element and the body in the base structure of the preferred embodiment;

FIG. 6 is a schematic view of the fixing element with an opening on the first end;

FIG. 7 is a schematic view of the fixing element with an opening on the second end;

FIG. 8 is a schematic view of the wire on the base structure mounted with a protection sheath according to the preferred embodiment;

FIG. 9 is a schematic view of the stator structure in the disclosed centrifugal fan; and

FIG. 10 is a schematic view of a centrifugal fan according to a preferred embodiment of the invention.

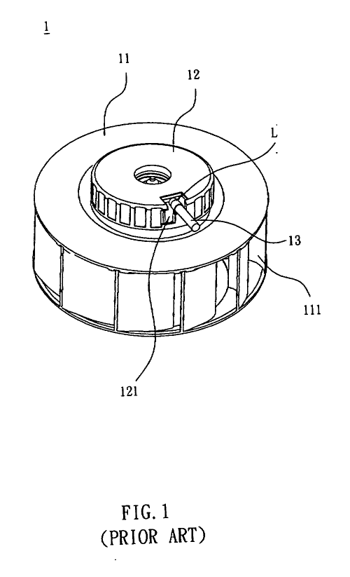

### DETAILED DESCRIPTION OF THE INVENTION

The present invention will be apparent from the following detailed description, which proceeds with reference to the accompanying drawings, wherein the same references relate to the same elements.

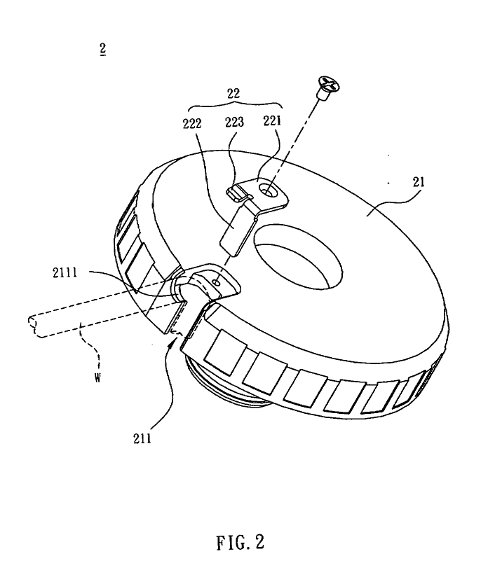

As shown in FIG. 2, a base structure 2 of a centrifugal fan according to a preferred embodiment of the invention can be connected with a wire W. The base structure 2 comprises a body 21 and a fixing element 22. The body 21 has a recess 211 at its edge. The wire W can be easily gone through the recess 211 and disposed at a positioning part 2111 of the recess 211.

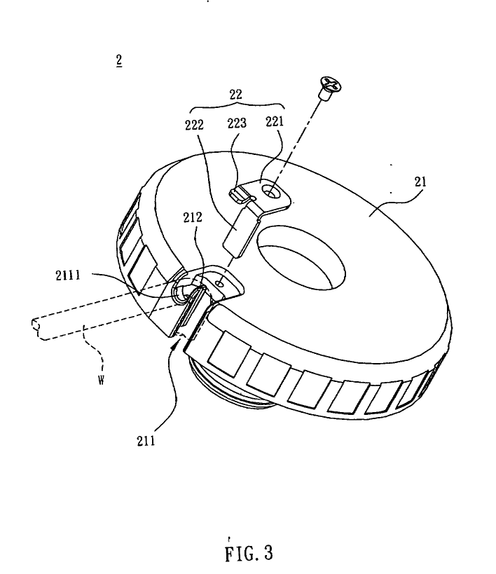

As shown in FIG. 3, the body 21 further has a stopping part 212 for more precisely positioning the wire W to the positioning part 2111. The stopping part 212 is protruded from the edge of the recess 211 and adjoined the positioning part 2111 for limiting the wire W to the positioning part 2111. The material of the body 21 is not limited in this embodiment. It can be plastic or metal.

With further reference to FIGS. 2 and 3, the fixing element 22 has a first end 221, a second end 222 and a bending part 223. The first end 221 is connected with the body 21. The first end 221 and the second end 222 correspondingly cover the recess 211. Furthermore, the bending part 223 is in contact with the wire W. With the limitation of the stopping part 212, the wire W is fixed to the positioning part 2111. The material of the fixing element 22 in this embodiment can be plastic or metal. Moreover, the wire W can first go through the recess 211 before connecting the first end 221 and the body 21. The wire W is thus installed and restrained within the recess 211. The wire W may be installed with the fixing element 22 in the body 21 simultaneously. The fixing element 22 is then fixed for fixing or limiting the wire W in the recess 211.

The first end 221 can be connected with the body 21 by screwing (as shown in FIGS. 2 and 3), gluing, locking, inserting, soldering, thermal welding, or ultrasonic welding.

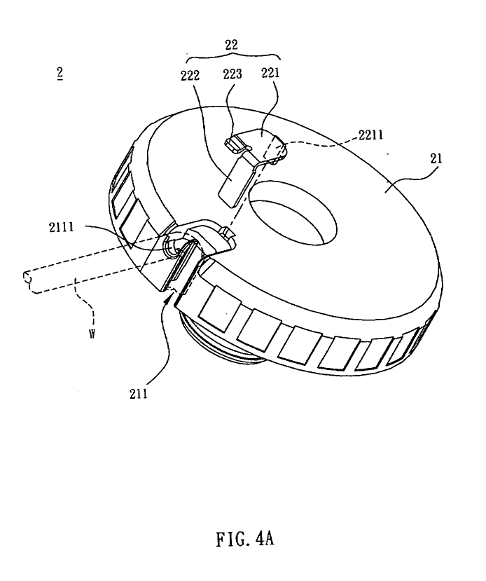

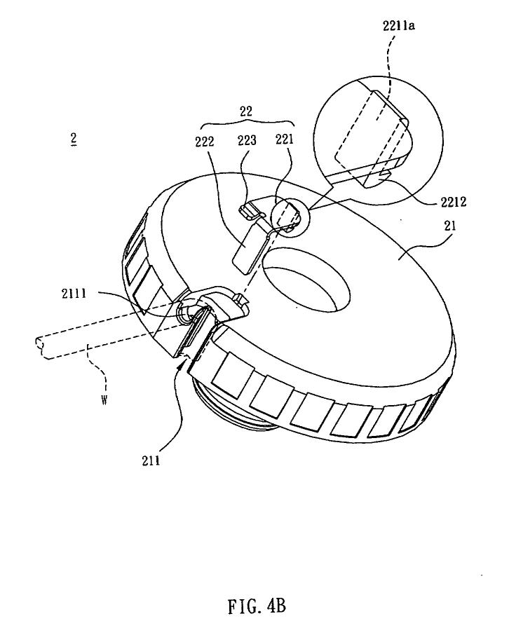

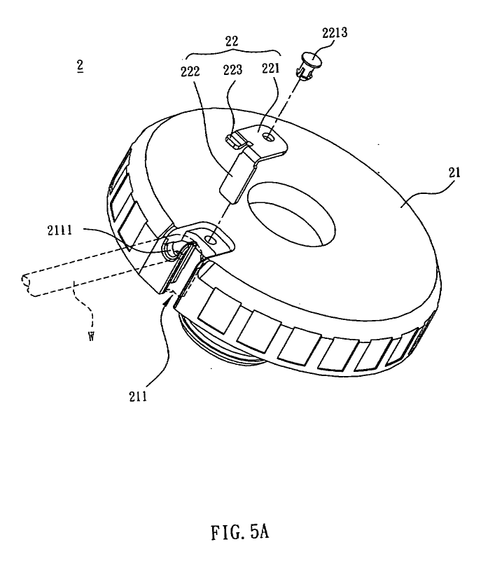

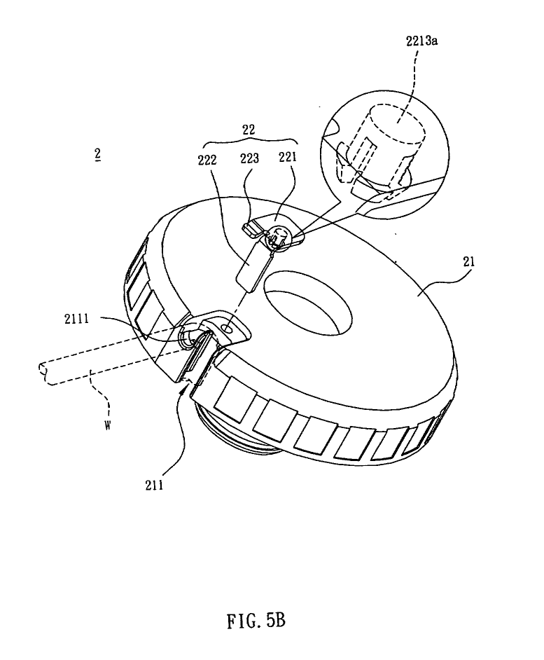

In addition, the first end 221 may have at least one protruding plate 2211 as shown in FIG. 4A. The protruding plate 2211 is connected with the body 21 by buckling. Furthermore, at least one hook 2212 can be set on the inner side or the outer side of a protruding plate 2211a of the first end (as shown in FIG. 4B) for enhancing the connection between the first end 221 and the body 21. Alternatively, the first end 221 may connect to the body 21 with a rivet 2213 as shown in FIG. 5A. Moreover, a rivet 2213a and the first end 221 can be integrally formed as a single piece as shown in FIG. 5B, so that the assembling can be further strengthened.

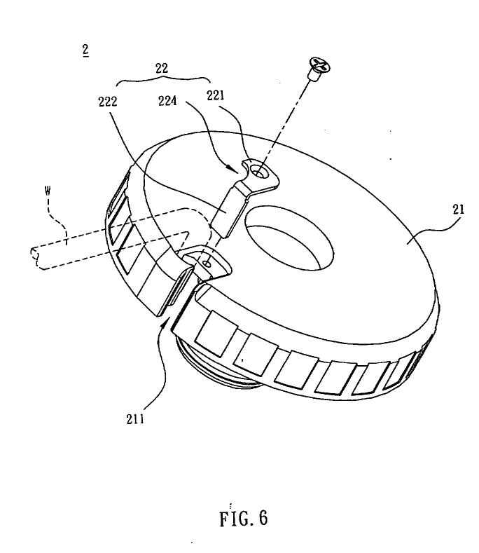

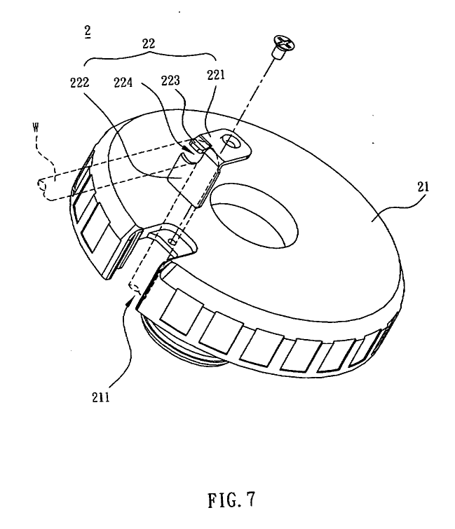

As shown in FIGS. 6 and 7, the first end 221 or the second end 222 can have an opening 224 as well. When the opening 224 is formed on the first end 221, the wire W first goes through the recess 211 before combining the fixing element 22 with the body 21. Thus, the wire W is fixed or restrained within the opening 224 of the first end 221. If the opening 224 is formed on the second end 222, the wire W preferably goes through the opening 224 before combining the fixing element 22 with the body 21 to achieve the goal of fixing or limiting the wire W. In this case, the recess 211 does not need to have a positioning part 2111 and/or stopping part 212.

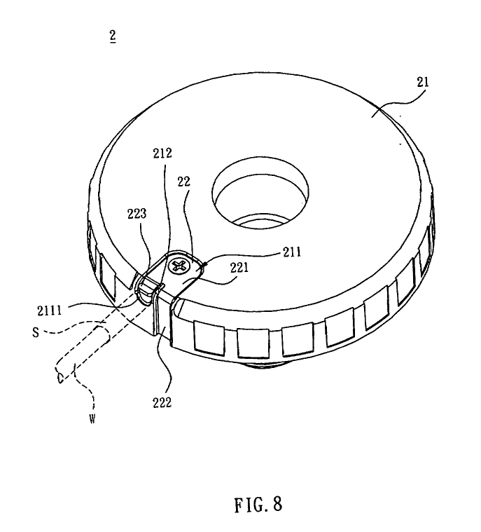

Moreover, as shown in FIG. 8, the wire W in this embodiment can be mounted with a protection sheath S at the fixing part on the body 21 or fixing element 22. The protection sheath S can protect the wire W after the assembly and enhance the fixing strength of the wire W to avoid movement or damage due to external forces. The protection sheath S can be an insulating or elastic material not limited to plastic or rubber. The protection sheath S is disposed between the wire W and the body 21 or between the wire W and the fixing element 22.

In the above-mentioned base structure 2, the wire W is fixed on the body 21 by the fixing element 22. Therefore, the wire W does not move due to external forces. Moreover, by covering the recess 211 with the fixing element 22, dusts or moisture is prevented from entering the body 21.

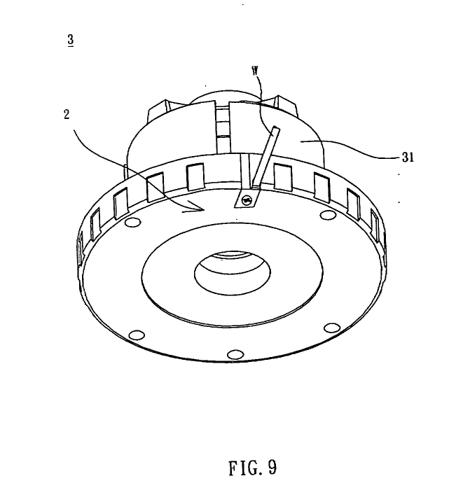

With simultaneous reference to FIGS. 8 and 9, a centrifugal fan stator structure 3 according to a preferred embodiment of the invention comprises a stator magnetic pole 31, the wire W, and the above-mentioned base structure 2. The stator magnetic pole 31 and the wire W are connected and disposed on the base structure 2. The stator magnetic pole 31 further comprises a driver circuit electrically coupled to an external system via the wire W.

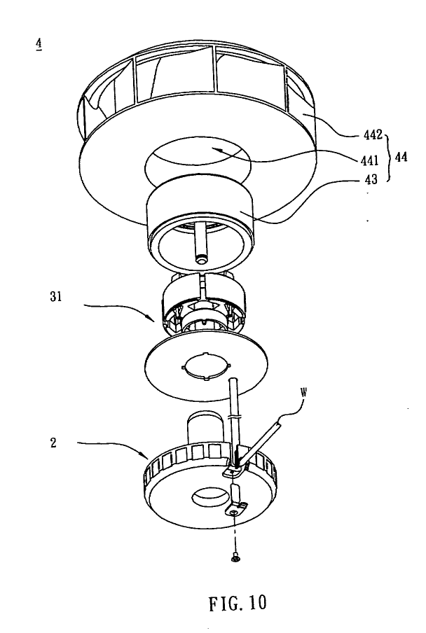

Please refer simultaneously to FIGS. 8 to 10. A centrifugal fan 4 according to a preferred embodiment of the invention comprises the wire W, the stator magnetic pole 31, the base structure 2, and a rotor structure 44. The rotor structure 44 further comprises a hub 441, a rotor magnetic pole 43, and several blades 442. The rotor structure 44 is disposed corresponding to the stator structure 3. More explicitly, the rotor magnetic pole 43 is disposed corresponding to the stator magnetic pole 31. The rotor magnetic pole 43 is disposed inside the hub 441, and the blades 442 are mounted around the edge of the hub 441.

In summary, the centrifugal fan and its stator and base structures of the invention enable a wire to readily and rapidly go through a recess of the body by a suitable combination of the body and the fixing element. The fixing element fixes the wire for convenience of assembly. Additionally, the wire can be first fixed to an opening of the fixing element before assembling the wire and the fixing element to the body. By this method, the wire can also be installed easily and rapidly. In comparison with the prior art, the invention uses a fixing element to fix the wire in the recess, enhancing the strength against external forces of the wire. Moreover, after the fixing element fixes the wire, it also covers the recess to prevent dusts and moisture from entering the centrifugal fan via the recess.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A centrifugal fan comprising:
a rotor structure; and
a stator structure having at least one base structure and at least one stator magnetic pole;
wherein the rotor structure and the stator structure are disposed correspondingly, the base structure comprises a body having at least one recess and at least one fixing element, the stator magnetic pole is disposed on the body, and the fixing element has a first end connected to the body and a second end covering the recess.

2. The centrifugal fan of claim 1, wherein the rotor structure comprises:
at least a hub; and
a plurality of blades installed around the edge of the hub.

3. The centrifugal fan of claim 2, wherein the rotor structure further comprises at least one rotor magnetic pole disposed inside the hub and corresponding to the stator magnetic pole.

4. The centrifugal fan of claim 1, wherein the stator structure further comprises a wire connected with the stator magnetic pole and limited inside the recess by the fixing element.

5. The centrifugal fan of claim 4, wherein the recess has a positioning part for fixing the wire.

6. The centrifugal fan of claim 4, wherein the first end or the second end has an opening to restrict the wire.

7. The centrifugal fan of claim 4, wherein the fixing element has a bending part for fixing the wire.

8. The centrifugal fan of claim 4 further comprising a protection sheath mounted on the wire and disposed between the wire and the body or between the wire and the fixing element.

9. The centrifugal fan of claim 8, wherein the material of the protection sheath is an insulating material, an elastic material, plastic or rubber.

10. The centrifugal fan of claim 1, wherein the material of the body is an elastic material or a metal material.

11. The centrifugal fan of claim 1, wherein the first end is connected to the body by screw fastening, gluing, locking, inserting, buckling, soldering, riveting, thermal welding, ultrasonic welding or other welding.

12. The centrifugal fan of claim 1, wherein the material of the fixing element is an elastic material or a metal material.

13. The centrifugal fan of claim 1, wherein the body has a stopping part protruding from the recess or the fixing element.

14. The centrifugal fan of claim 1, wherein the recess is located on the edge of the body.

15. The centrifugal fan of claim l, wherein the fixing element comprises at least one protruding plate or at least one hook for fixing the fixing element and the body.

16. The centrifugal fan of claim 15, wherein the protruding plate or the hook is integrally formed on the fixing element as a single piece.

17. A stator structure, comprising:
at least one stator magnetic pole; and
at least one base structure disposed on the base structure, wherein the base structure comprises a body and at least one fixing element, the body has at least one recess, the stator magnetic pole is disposed inside the body, and the fixing element has a first end connecting with the body and a second end covering the recess.

18. The stator structure of claim 17, wherein the fixing element comprises at least one protruding plate or at least one hook for fixing the fixing element and the body.

19. The stator structure of claim 17, wherein the stator structure further comprises a wire connected with the stator magnetic pole and restrained within the recess by the fixing element.

20. The stator structure of claim 19, wherein the first end or the second end has an opening to restrict the wire.
